(19) United States
(12) Patent Application Publication
(10) Pub. No.: US 2024/0378563 A1
(43) Pub. Date: Nov. 14, 2024

(54) System and Method for Evaluation Using a Recruitment Platform

(71) Applicant: Sports Stats LLC, Galveston, TX (US)

(72) Inventor: Brion Keith Blackmon, Houston, TX (US)

(21) Appl. No.: 18/661,693

(22) Filed: May 12, 2024

Related U.S. Application Data
(60) Provisional application No. 63/466,252, filed on May 13, 2023.

(51) Int. Cl. G06Q 10/1053

(52) U.S. Cl. CPC G06Q 10/1053

(57) ABSTRACT

Various implementations directed to a system and method for evaluation using a recruitment platform are provided. In one implementation, a method may include receiving coach profile data from a sports coach associated with one or more athletes. The method may also include receiving athlete profile data from the one or more athletes. The method may further include receiving event tracking data from a statistician for an athletics competition associated with the sports coach and the one or more athletes. The method may additionally include determining event statistics data for the athletics competition based on the event tracking data. The method may also include updating the athlete profile data for the one or more athletes based on the event statistics data. The method may include generating athlete profile visualization data for the one or more athletes based on the updated athlete profile data.

### CROSS-REFERENCE TO RELATED APPLICATIONS

This application claims the benefit of U.S. provisional patent application Ser. No. 63/466,252, filed May 13, 2023 and titled SYSTEM AND METHOD FOR EVALUATION USING A RECRUITMENT PLATFORM, the entire disclosure of which are herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Third parties may evaluate prospective athletes for various purposes, including to identify the best athletes for a particular sport so that these athletes can be recruited to join a sports program and/or sports team involved with the sport. In some scenarios, a prospective athlete may be a student-athlete attending elementary school, middle school, high school, junior college, or college, where the prospective athlete may participate in at least one sport on behalf of his or her academic institution. In such scenarios, a third party who evaluates a prospective athlete may be a coach and/or a recruiter associated with a school, college, sports program, sports team, and/or the like.

In addition, the third party may evaluate the prospective athlete based on a number of factors, such as the prospective athlete's performances during athletics competitions. To evaluate the prospective athlete's performances, the third party may utilize event statistics data that was recorded for the prospective athlete with respect to these athletics competitions. For example, the prospective athlete may be a high school football quarterback, and a third party (e.g., a college football coach or a college football recruiter) may evaluate the athlete to determine if the athlete should be recruited to join a college football program associated with the third party. In particular, in such an example, the third party may evaluate the prospective athlete based on event statistics data recorded for the athlete with respect to his high school football games, where the event statistics data may correspond to passing yards, passing touchdowns, interceptions, and/or the like. Thus, the evaluation and/or recruitment of a prospective athlete may be facilitated by having access to such event statistics data.

### SUMMARY

Described herein are implementations of various technologies relating to a system and method for evaluation using a recruitment platform. In one implementation, a method may include receiving, by a recruitment platform, coach profile data from a sports coach associated with one or more athletes, where the coach profile data corresponds to the sports coach. The method may also include receiving, by the recruitment platform, athlete profile data from the one or more athletes, where the athlete profile data corresponds to the one or more athletes. The method may further include receiving, by the recruitment platform, event tracking data from a statistician for an athletics competition associated with the sports coach and the one or more athletes, where the event tracking data corresponds to events that occur during the athletics competition. The method may additionally include determining, by the recruitment platform, event statistics data for the athletics competition based on the tracking data, where the event statistics data for a respective athlete corresponds to one or more statistics associated with the respective athlete during the athletics competition. In addition, the method may include updating, by the recruitment platform, the athlete profile data for the one or more athletes based on the event statistics data. The method may also include generating, by the recruitment platform, athlete profile visualization data for the one or more athletes based on the updated athlete profile data, where the athlete profile visualization data is configured for use in generating one or more athlete profile interfaces for a computing device. The method may further include transmitting, by the recruitment platform, the athlete profile visualization data to the computing device.

In another implementation, a recruiting platform may include one or more processors and a memory. The memory may include a plurality of program instructions which, when executed by the one or more processors, cause the one or more processors to: receive coach profile data from a sports coach associated with one or more athletes, where the coach profile data corresponds to the sports coach; receive athlete profile data from the one or more athletes, where the athlete profile data corresponds to the one or more athletes; receive event tracking data from a statistician for an athletics competition associated with the sports coach and the one or more athletes, where the event tracking data corresponds to events that occur during the athletics competition; determine event statistics data for the athletics competition based on the tracking data, where the event statistics data for a respective athlete corresponds to one or more statistics associated with the respective athlete during the athletics competition; update the athlete profile data for the one or more athletes based on the event statistics data; generate athlete profile visualization data for the one or more athletes based on the updated athlete profile data, where the athlete profile visualization data is configured for use in generating one or more athlete profile interfaces for a computing device; and transmit the athlete profile visualization data to the computing device.

In yet another implementation, a non-transitory computer-readable medium may have stored thereon a plurality of computer-executable instructions. The plurality of computer-executable instructions may, when executed by a computer, cause the computer to: receive coach profile data from a sports coach associated with one or more athletes, where the coach profile data corresponds to the sports coach; receive athlete profile data from the one or more athletes, where the athlete profile data corresponds to the one or more athletes; receive event tracking data from a statistician for an athletics competition associated with the sports coach and the one or more athletes, where the event tracking data corresponds to events that occur during the athletics competition; determine event statistics data for the athletics competition based on the tracking data, where the event statistics data for a respective athlete corresponds to one or more statistics associated with the respective athlete during the athletics competition; update the athlete profile data for the one or more athletes based on the event statistics data; generate athlete profile visualization data for the one or more athletes based on the updated athlete profile data, where the athlete profile visualization data is configured for use in generating one or more athlete profile interfaces for a computing device; and transmit the athlete profile visualization data to the computing device.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a system using a recruitment platform in accordance with implementations of various techniques described herein.

FIGS. 2-8 illustrate graphical interfaces in accordance with implementations of various techniques described herein.

FIG. 9 illustrates a flow diagram of a method for using a recruiting platform in accordance with implementations of various techniques described herein.

FIG. 10 illustrates a block diagram of a hardware configuration in which one or more various technologies described herein may be incorporated and practiced.

### DETAILED DESCRIPTION

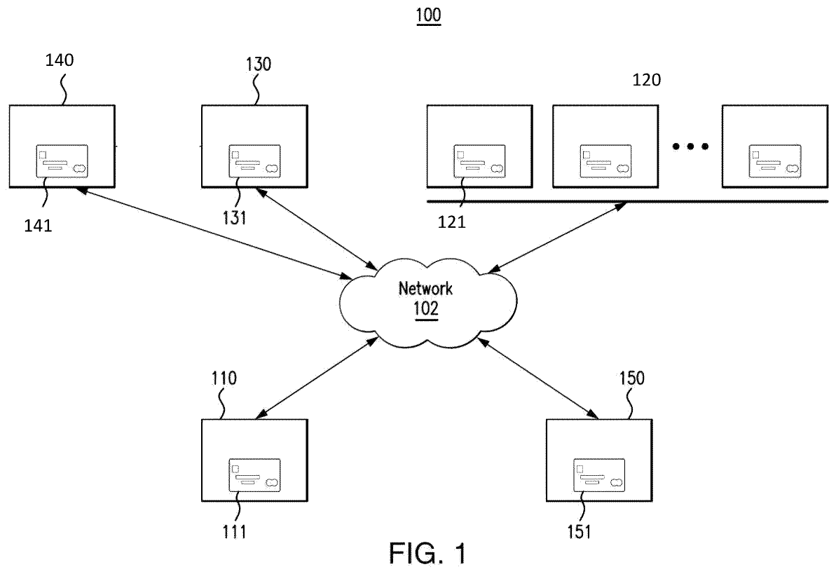

Various implementations directed to a system and method for evaluation using a recruitment platform will now be described in the following paragraphs with reference to FIGS. 1-10.

As noted above, third parties may evaluate prospective athletes for various reasons, including to identify the best prospective athletes for a particular sport and to then recruit these prospective athletes to join a sports team and/or a sports program involved with the sport. A sport may include any form of athletics and/or exercise known to those skilled in the art. For example, a sport may include, but is not limited to, the following: football, rugby, basketball, baseball, golf, cricket, tennis, swimming, soccer, track and field, field hockey, and/or the like. The sport may also include any organized or non-organized form of athletics and/or exercise known to those skilled in the art.

A prospective athlete may be any individual who participates in at least one sport. In one implementation, the prospective athlete may be a student-athlete attending elementary school, middle school, high school, junior college, or college, where the prospective athlete may participate in at least one sport on behalf of his or her academic institution. For example, the prospective athlete may be a high school baseball player, a junior college football player, and/or the like. In another implementation, the prospective athlete may be an athlete who participates in at least one sport as part of an organized sports association, where the organized sports association may be unaffiliated with an academic institution. For example, the prospective athlete may be a youth basketball player who participates in basketball tournaments as a member of an amateur basketball association.

A third party who evaluates prospective athletes may be hereinafter referred to as an evaluator. In particular, the evaluator may be any individual or entity who performs assessments of prospective athletes with respect to at least one sport. In one implementation, the evaluator may be a coach or recruiter who is involved with a particular sport and who may be associated with a particular sports team, sports program, and/or sports organization. For example, the evaluator may be a college football recruiter, a junior college baseball coach, an amateur basketball association coach, and/or the like. In such an implementation, the evaluator may assess prospective athletes in order to identify the best prospective athletes for a sport and to then recruit these prospective athletes to join a sports team, sports program, and/or sports organization associated with the evaluator.

As noted above, the evaluator may assess a prospective athlete based on any number of factors, including the prospective athlete's performance during one or more athletics competitions. An athletics competition may be any form of contest that involves athletes and/or groups of athletes (e.g., sports teams) competing amongst each other in at least one sport. Examples of an athletics competition may include, but is not limited to, the following: a game, a scrimmage, a practice, a tournament, a combine, an invitational event, an exhibition, a match, and/or the like.

To assess the prospective athlete's performance, the evaluator may analyze event statistics data recorded for the prospective athlete with respect to the one or more athletics competitions. Event statistics data may refer to any type of data that can be collected and/or recorded for a prospective athlete participating in a sport, where the data may correspond to one or more statistical categories relating to the sport. Further, the event statistics data may include data that corresponds to a single athletics competition, multiple athletics competitions over the course of a single year or season, multiple athletics competitions over the course of multiple years or seasons, and/or the like. In addition, the event statistics data may also correspond to one or more statistical categories that relate to a specific position (e.g., football quarterback) assigned to the prospective athlete during the one or more athletics competitions. For example, the event statistics data recorded for the prospective athlete may include, but is not limited to, data that corresponds to the following: total rushing yards for a high school football running back with respect to a single season; total passing touchdowns for a junior college football quarterback with respect to the past two seasons; total assists for an amateur basketball association point guard with respect to a single tournament; and/or the like.

Using such event statistics data, the evaluator may be able to appraise a level of performance by the prospective athlete during the one or more athletics competitions. Based on this appraisal, the evaluator may then be able to determine whether the prospective athlete is to be recruited to join a sports team, sports program, and/or sports organization associated with the evaluator. For example, the prospective athlete may be a high school football quarterback, and the evaluator may be a college football coach who utilizes the event statistics data to decide if the athlete should be recruited to join a college football program associated with the evaluator (e.g., to decide if the athlete is to be offered a college football scholarship).

Thus, the evaluation and/or recruitment of a prospective athlete may be facilitated by having access to event statistics data recorded for the athlete during one or more athletics competitions. However, in some instances, the event statistics data recorded for the prospective athlete may not be accurate. For example, the event statistics data may be incomplete. In another example, the event statistics data may have been provided by those who may be biased, such as the prospected athlete himself or herself, one or more associates (e.g., a parent, a friend, etc.) of the prospective athlete, and/or the like. In such an example, the event statistics data may be exaggerated for the athlete and, therefore, may be unreliable. Such inaccurate event statistics data may be a hindrance to a proper evaluation and/or recruitment of a prospective athlete by an evaluator.

In view of the above, various implementations of a system and method for evaluation using a recruitment platform are described herein, where the recruitment platform may be used to facilitate access to accurate and updated event statistics data with respect to a prospective athlete. In some implementations, the recruiting platform may be used to receive event tracking data from a statistician for an athletics competition associated with a sports coach and one or more prospective athletes, where the event tracking data corresponds to events that occur during an athletics competition. The recruiting platform may be used to determine event statistics data for the athletics competition based on the event tracking data, where the event statistics data for a prospective athlete corresponds to one or more statistics associated with the athlete during the athletics competition. The recruiting platform may also update athlete profile data for the one or more prospective athletes based on the event statistics data. The recruiting platform may further generate athlete profile visualization data for the one or more athletes based on the updated athlete profile data, where the athlete profile visualization data is configured for use in generating one or more athlete profile interfaces. The recruiting platform may transmit the athlete profile visualization data to a computing device, which may then render one or more athlete profile interfaces that display the updated athlete profile data, including the event statistics data.

### I. System

FIG. 1 illustrates a schematic diagram of a system 100 using a recruitment platform 110 in accordance with implementations of various techniques described herein. The system 100 may include one or more networks 102, the recruitment platform 110, a plurality of prospective athletes 120, a sports coach 130, a statistician 140, and an evaluator 150.

The recruitment platform 110, the prospective athletes 120, the sports coach 130, the statistician 140, and/or the evaluator 150 may be in communication with one another via the one or more networks 102. The one or more networks 102 may include, but are not limited to, one or more of the following components: a local area network (LAN), a wide area network (WAN) (e.g., the Internet), a mobile network, a cellular network, a virtual network, and/or any other public and/or private network known in the art capable of supporting any type of communication among two or more of the elements of the system 100. For example, such communication may be in the form of emails, direct messages, text messages, multimedia messages, data file transfers, and/or the like.

The recruitment platform 110 may be utilized by the prospective athletes 120, the sports coach 130, the statistician 140, and/or the evaluator 150 to facilitate an assessment and/or a recruitment of the prospective athletes 120. In some implementations, the recruitment platform 110 may be operated by and/or provided by an entity, where the entity may be unrelated to, and/or unaffiliated with, the prospective athletes 120, the sports coach 130, the statistician 140, and/or the evaluator 150. In other implementations, the entity may be related to, and/or affiliated with, the statistician 140.

The recruitment platform 110 may be a software-based system, a hardware-based system, or combinations thereof. In particular, the recruitment platform 110 may include, and/or may be implemented using, at least one computing device 111. The at least one computing device 111 may include any type and/or number of computing devices known to those skilled in the art, including one or more servers, one or more cloud computing systems, and/or the like. Various implementations of the at least one computing device 111 are discussed in a later section.

As further explained in a later section, the recruitment platform 110 (i.e., via the at least one computing device 111) may be configured to perform one or more operations described herein. In one implementation, the one or more operations that may be performed by the computing device 111 may include: receiving coach profile data from the sports coach 130, receiving athlete profile data from the prospective athletes 120, receiving event tracking data from the statistician 140 for an athletics competition associated with the sports coach 130 and the prospective athletes 120, determining event statistics data for the athletics competition based on the event tracking data, updating the athlete profile data based on the event statistics data, generating athlete profile visualization data for the prospective athletes 120 based on the updated athlete profile data, and/or transmitting the athlete profile visualization data. Further, while one or more operations may be described herein as being performed by a single computing device 111 for the recruitment platform 110, those skilled in the art will understand that these operations may be performed by a plurality of computing devices 111 for the recruitment platform 110.

Each of the prospective athletes 120 may be similar to the prospective athlete described above. In particular, a prospective athlete 120 may be any individual who participates in at least one sport. This sport may be similar to the sport described above. Further, with respect to FIG. 1, each of the plurality of prospective athletes 120 shown is a member of the same sports team, sports program, and/or sports organization. In one example, a prospective athlete 120 may be a student-athlete attending elementary school, middle school, high school, junior college, or college, where the prospective athlete 120 may participate in at least one sport on behalf of his or her academic institution. In another example, the prospective athlete 120 may be an athlete who participates in at least one sport as part of an organized sports association, where the organized sports association may be unaffiliated with an academic institution. In further implementations, each prospective athlete 120 may also encompass one or more associates and/or representatives of the individual participating in the at least one sport, including one or more parents of the individual, one or more friends of the individual, one or more agents of the individual, and/or the like.

In addition, each prospective athlete 120 may own, operate, and/or be associated with at least one computing device 121. The at least one computing device 121 may include any type and/or number of computing devices known to those skilled in the art, including one or more mobile devices, one or more tablet devices, one or more laptop devices, and/or the like. Various implementations of the at least one computing device 121 are discussed in a later section. As further explained in a later section, the at least one computing device 121 may be configured to perform one or more operations described herein, including communicating with the recruitment platform 110 via the computing device 111 and the one or more networks 102. Further, while one or more operations may be described herein as being performed by a single computing device 121 of a prospective athlete 120, those skilled in the art will understand that these operations may be performed by a plurality of computing devices 121 of the prospective athlete 120.

The sports coach 130 may be any type of coach and/or instructor associated with the plurality of prospective athletes 120 shown in FIG. 1. As noted above, with respect to FIG. 1, each of the plurality of prospective athletes 120 shown is a member of the same sports team, sports program, and/or sports organization. The sports coach 130 may be an individual who is in a position to coach, teach, instruct, manage, and/or lead these prospective athletes 120 with respect to their participation in at least one sport. For example, the sports coach 130 may be a head football coach for a high school football team that includes the prospective athletes 120. In another example, the sports coach 130 may be an assistant basketball coach for a youth basketball team that includes the prospective athletes 120 for an amateur basketball association. In further implementations, the sports coach 130 may also encompass one or more administrators and/or contributors associated with the same sports team, sports program, and/or sports organization as the prospective athletes 120 of FIG. 1. For example, the sports coach 130 may also include a guidance counselor and/or an executive assistant employed at a high school associated with the high school football team mentioned in the previous example.

In addition, the sports coach 130 may own, operate, and/or be associated with at least one computing device 131. The at least one coach device 131 may include any type and/or number of computing devices known to those skilled in the art, including one or more mobile devices, one or more tablet devices, one or more laptop devices, and/or the like. Various implementations of the at least one computing device 131 are discussed in a later section. As further explained in a later section, the at least one computing device 131 may be configured to perform one or more operations described herein, including communicating with the recruitment platform 110 via the computing device 111 and the one or more networks 102. Further, while one or more operations may be described herein as being performed by a single computing device 131 for the sports coach 130, those skilled in the art will understand that these operations may be performed by a plurality of computing devices 131 for the sports coach 130.

The statistician 140 may be an individual who observes at least one athletics competition associated with the sports coach 130 and the prospective athletes 120 of FIG. 1. The at least one athletics competition may be similar to the athletics competition described above. Further, as further described herein, the statistician 140 may observe an athletics competition associated with the sports coach 130 and the prospective athletes 120 of FIG. 1, and the statistician 140 may then provide event tracking data for the athletics competition. In particular, the event tracking data may correspond to a log of events that occur during the athletics competition, such that the event tracking data may be recorded by the statistician 140 during the athletics competition. In some implementations, the statistician 140 may be affiliated with the sports coach 130 and/or the prospective athletes 120, such that the statistician 140 may be a member of the same sports team, sports program, and/or sports organization. For example, the statistician 140 may be an employee of the high school associated with the high school football team mentioned in a previous example. In another example, the statistician 140 may be a parent of one of the prospective athletes 120. In other implementations, the statistician 140 may be unaffiliated with the sports coach 130 and/or the prospective athletes 120. For example, the statistician 140 may be a third-party or a professional recordkeeper who has been contracted by the entity associated with the recruiting platform 110.

In addition, the statistician 140 may own, operate, and/or be associated with at least one computing device 141. The at least one computing device 141 may include any type and/or number of computing devices known to those skilled in the art, including one or more mobile devices, one or more tablet devices, one or more laptop devices, and/or the like. Various implementations of the at least one computing device 141 are discussed in a later section. As further explained in a later section, the at least one computing device 141 may be configured to perform one or more operations described herein, including recording the event tracking data and then transmitting the event tracking data to the recruiting platform 110 via the computing device 111 and the one or more networks 102. Further, while one or more operations may be described herein as being performed by a single computing device 141 for the statistician 140, those skilled in the art will understand that these operations may be performed by a plurality of computing devices 141 for the statistician 140.

The evaluator 150 may be similar to the evaluator described above. In particular, the evaluator 150 may be any individual or entity who performs assessments of athletes with respect to at least one sport. The evaluator 150 may be unaffiliated with the sports coach 130 and/or the prospective athletes 120. For example, the evaluator 150 may be a college football recruiter who wishes to perform an assessment on at least one of the prospective athletes 120 of FIG. 1, such that the evaluator 150 may be able to determine whether the athlete 120 is to be recruited to join a college football program associated with the evaluator 150.

In addition, the evaluator 150 may own, operate, and/or be associated with at least one computing device 151. The at least one computing device 151 may include any type and/or number of computing devices known to those skilled in the art, including one or more mobile devices, one or more tablet devices, one or more laptop devices, and/or the like. Various implementations of the at least one computing device 151 are discussed in a later section. As further explained in a later section, the at least one computing device 151 may be configured to perform one or more operations described herein, including communicating with the recruitment platform 110 via the computing device 111 and the one or more networks 102. Further, while one or more operations may be described herein as being performed by a single computing device 151 for the evaluator 150, those skilled in the art will understand that these operations may be performed by a plurality of computing devices 151 for the evaluator 150.

In addition, the computing devices mentioned above may be configured to perform one or more operations as described herein using one or more applications downloaded to, installed in, and/or activated in the computing devices. In one implementation, the entity operating and/or providing the recruitment platform 110 may also provide and/or host these applications. Additionally, the recruitment platform 110 and the computing devices mentioned above may communicate with one another using any technique known to those skilled in the art. In one example, though not shown in FIG. 1, the recruitment platform 110 and the computing devices of the prospective athletes 120, the sports coach 130, the statistician 140, and/or the evaluator 150 may communicate with one another using one or more application programming interfaces (APIs) associated with the one or more applications. In another example, the computing devices mentioned above may have a web browser stored and operating thereon, such that the web browser may be used to communicate with the recruitment platform 110 and the other computing devices of the system 100 via the one or more networks 102.

Moreover, although the system 100 is presented in one arrangement, other implementations may include one or more elements of the system 100 in different arrangements and/or with additional elements. In one example, though one coach 130 is shown as being associated with the group of prospective athletes 120, those skilled in the art will understand that the implementations described herein may be applied to scenarios in which additional coaches 130 interact with additional groups of prospective athletes 120. In particular, those skilled in the art will understand that the additional coaches 130 and their associated groups of prospective athletes 120 may similarly utilize the recruitment platform 110 as described herein. In another example, though one evaluator 140 and/or one statistician 150 is shown as communicating with the recruitment platform 110, those skilled in the art will understand that the implementations described herein may be applied to scenarios in which multiple evaluators and/or statisticians may communicate with the recruitment platform 110.

### II. Operation

One or more elements of the system 100 may be used to perform one or more operations, such as those described herein, in order to facilitate an assessment and/or a recruitment of a prospective athlete 120. In one implementation, and as further described below, the recruiting platform 110 and the computing devices described herein may be used to: receive coach profile data from the sports coach 130, receive athlete profile data from the prospective athletes 120, receive event tracking data from the statistician 140 for an athletics competition associated with the sports coach 130 and the prospective athletes 120, determine event statistics data for the athletics competition based on the event tracking data, update the athlete profile data based on the event statistics data, generate athlete profile visualization data for the prospective athletes 120 based on the updated athlete profile data, and/or transmit the athlete profile visualization data to a computing device.

### A. Sports Coach Registration

Before the recruitment platform 110 can be used to facilitate an assessment and/or a recruitment of a prospective athlete 120, the sports coach 130 associated with the prospective athlete 120 may initially need to complete a coach registration process with the platform 110. To do so, prior to starting the coach registration process, the sports coach 130 may use the computing device 131 to download, install, and/or activate an application associated with the platform 110. As noted above, the entity operating and/or providing the platform 110 may provide and/or host the application. Via the application, the sports coach 130 may use the computing device 131 to communicate with the platform 110 via the one or more networks 102. In one implementation, the application may be a primary application associated with the recruitment platform 110. Such an application may be referred to herein as a sports application for the platform 110. In another implementation, the application may be a specialized application associated with the recruitment platform 110 that is designed specifically for sports coaches. Such an application may be referred to herein as a coaches application for the platform 110.

While the implementations herein are discussed in terms of an application installed on the computing device 131, those skilled in the art will understand that other implementations may be applicable, as well. For example, the sports coach 130 may use a web browser installed on the computing device 131 to communicate with the recruitment platform 110 via the one or more networks 102. In particular, the entity operating and/or providing the recruitment platform 110 may provide and/or host a web portal through which the sports coach 130 may access the platform 110. In one implementation, the web portal may be a primary web portal associated with the recruitment platform 110. Such a web portal may be referred to herein as a main portal for the platform 110. In another implementation, the web portal may be a specialized web portal that is designed specifically for sports coaches. Such a web portal may be referred to herein as a coaches portal for the platform 110.

After the application has been downloaded, installed, and/or activated on the computing device 131, the sports coach 130 may begin the registration process. In particular, the computing device 131 may, via the application, display a prompt indicating that the sports coach 130 is to provide coach profile data for the sports coach 130. The sports coach 130 may then provide the coach profile data to the application via one or more input devices of the computing device 131. In one implementation, the sports coach 130 may be prompted to provide coach profile data that includes data corresponding to a username, a password, and/or the like for the sports coach 130. In another implementation, the sports coach 130 may be prompted to provide coach profile data that includes data corresponding to biographical information associated with the sports coach 130. Such biographical information may include a full name, location, current occupation (e.g., coach for a particular sports team, sports program, or sports organization), professional history, contact information (e.g., phone number, email address, etc.), and/or other details associated with the sports coach 130. In some implementations, the location for the sports coach 130 may be determined using the computing device 131 in conjunction with one or more satellite navigation systems (e.g., the Global Positioning System (GPS)).

After the sports coach 130 provides the coach profile data to the computing device 131 (e.g., via the application), the computing device 131 may then transmit the coach profile data to the recruitment platform 110. After receiving the coach profile data, the recruitment platform 110 may store the data in one or more databases located in memory (e.g., one or more computer-readable storage media) associated with the computing device 111. The one or more databases may be generated or organized using any techniques known to those skilled in the art. The recruitment platform 110 may then generate a coach profile for the sports coach 130 based on the coach profile data. The platform 110 may store data corresponding to the coach profile in the one or more databases, thereby completing the coach registration process for the sports coach 130.

Once the coach registration process has been completed, the recruitment platform 110 may be able to generate coach profile visualization data for the sports coach 130 using the coach profile data. In particular, the coach profile visualization data can be used to generate and display a coach profile interface, where the displayed coach profile interface may be a displayed version of the coach profile. The recruitment platform 110 may transmit the coach profile visualization data for the sports coach 130 to a computing device (e.g., the computing device 151). The computing device may then be able to generate and display the coach profile interface corresponding to the sports coach 130, where the interface may include the biographical information provided by the sports coach 130. In a further example, the sports coach 130 may provide and/or upload media data (e.g., picture data, video data, audio data, and/or the like) to the recruitment platform 110 (e.g., via the application of the computing device 131), such that the media data can be included in the coach profile interface for the sports coach 130. In some implementations, the recruiting platform 110 may generate the coach profile interface as described above and then provide the coach profile interface via a publicly accessible profile webpage associated with the sports coach 130, such as through a website associated with the platform 110.

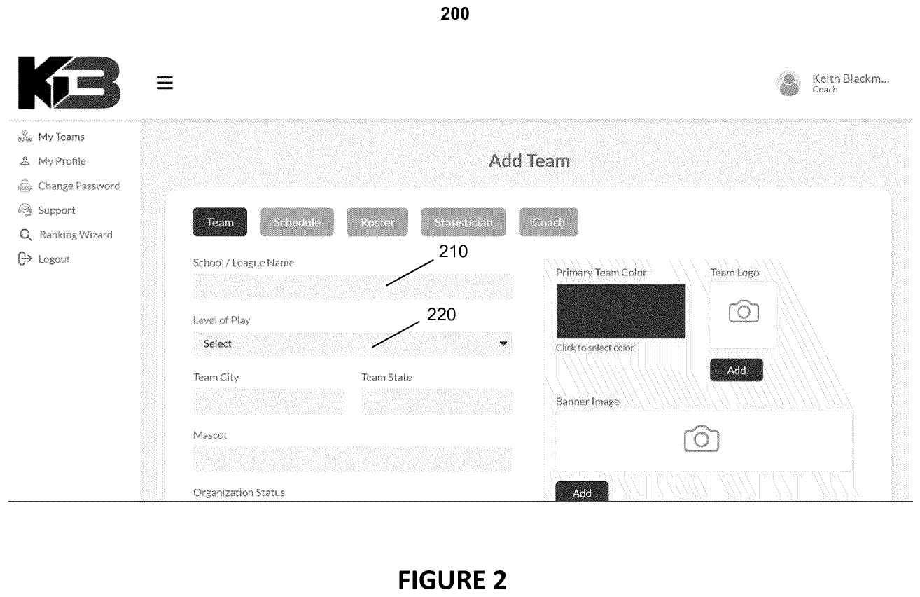

In one implementation, after the coach registration process has been completed, the sports coach 130 may provide additional coach data to the application via one or more input devices of the computing device 131. The additional coach data may include data relating to a sports team associated with the sports coach 130, data relating to a schedule of athletics competitions for the sports team, data relating to a statistician 140 associated with the sports team, and/or the like. For example, FIG. 2 illustrates a graphical interface 200 in accordance with implementations of various techniques described herein, where the computing device 131 may be configured to display the graphical interface 200 to the sports coach 130. As shown, the graphical interface 200 may display a plurality of input fields, including an entry field 210 and a dropdown box 220. Using these input fields, the sports coach 130 can provide data relating to the coach's 130 sports team via one or more input devices of the computing device 131. As shown in FIG. 2, such data may correspond to a name of a school or league associated with the sports team, a level of play for the sports team, location information, mascot information, a primary team color, a team logo, and/or the like.

After the sports coach 130 provides the additional coach data to the computing device 131 (e.g., via the application), the computing device 131 may then transmit the additional coach data to the recruitment platform 110. The platform 110 may store the additional coach data in its one or more databases, such that the data may be associated with the sports coach 130 in the one or more databases. For example, information on the coach's 130 sports team may be added as part of the coach profile for the sports coach 130 in the one or more databases.

### B. Prospective Athlete Registration

After the coach registration process has been completed, the computing device 131 may, via the application, display a prompt indicating that the sports coach 130 is to assign prospective athletes 120 to his or her coach profile. To do so, the sports coach 130 may provide athlete contact data to the application via the one or more input devices of the computing device 131. The athlete contact data may include data corresponding to a name, contact information (e.g., phone number, email address, etc.), a location, and/or other details associated with each of the prospective athletes 120.

After receiving the athlete contact data from the sports coach 130, the computing device 131 may transmit the athlete contact data to the recruitment platform 110. The recruitment platform 110 may then store the athlete contact data in its one or more databases, such that the athlete contact data may be associated with the coach profile of the sports coach 130 in the one or more databases. In one implementation, the recruitment platform 110 may use the athlete contact data to extract information on the prospective athletes 120. Using this information, the platform 110 may then assign these prospective athletes 120 to the sports team associated with the coach profile of the coach 130.

In addition, the recruitment platform 110 may use the contact information from the athlete contact data to transmit request data to the computing device 121 of each of the prospective athletes 120, where the request data corresponds to a request to join the coach's sports team on the platform 110. In one example, the recruitment platform 110 may transmit the request data to the computing device 121 of each prospective athlete 120 via email, text message, and/or the like.

The request data may include a hyperlink that can be used by the computing device 121 of each athlete 120 to download, install, and/or activate an application associated with the platform 110. As noted above, the entity operating and/or providing the platform 110 may provide and/or host the application. Via the application, each prospective athlete 120 may use his or her computing device 121 to communicate with the platform 110 via the one or more networks 102. In one implementation, the application may be the sports application mentioned above. In another implementation, the application may be a specialized application associated with the recruitment platform 110 that is designed specifically for prospective athletes. Such an application may be referred to herein as an athletes application for the platform 110. In addition, by downloading, installing, and/or activating the application onto his or her computing device 121, a prospective athlete 120 may consent to being assigned to the sports team associated with the sports coach 130 with respect to the recruitment platform 110.

Further, while the implementations herein are discussed in terms of an application installed on the computing device 121, those skilled in the art will understand that other implementations may be applicable, as well. For example, a prospective athlete 120 may use a web browser installed on the computing device 121 to communicate with the recruitment platform 110 via the one or more networks 102. In particular, the entity operating and/or providing the recruitment platform 110 may provide and/or host a web portal through which the prospective athlete 120 may access the platform 110. In one implementation, the web portal may be the main portal mentioned above. In another implementation, the web portal may be a specialized web portal that is designed specifically for prospective athletes. Such a web portal may be referred to herein as an athletes portal for the platform 110.

After the application has been downloaded, installed, and/or activated on the computing device 121 of a prospective athlete 120, the athlete 120 may begin the registration process. In particular, the computing device 121 may, via the application, display a prompt indicating that the prospective athlete 120 is to provide athlete profile data for the athlete 120. The prospective athlete 120 may then provide the athlete profile data to the application via one or more input devices of the computing device 121. In one implementation, the prospective athlete 120 may be prompted to provide athlete profile data that includes data corresponding to a username, a password, and/or the like for the prospective athlete 120.

In another implementation, the prospective athlete 120 may be prompted to provide athlete profile data that includes data corresponding to biographical information associated with the athlete 120. Such biographical information may include a full name of the athlete 120, a location for the athlete 120, a date of birth, current educational level, educational history, one or more academic statistics (e.g., a grade point average, standardized test scores, etc.), one or more physical measurements (e.g., height and weight), contact information (e.g., one or more social media addresses), a personal biographical summary, and/or other details associated with the prospective athlete 120. In some implementations, the location for the prospective athlete 120 may be determined using the computing device 121 in conjunction with the one or more satellite navigation systems mentioned above.

In addition, the prospective athlete 120 may be prompted to provide athlete profile data that includes data corresponding to sports information associated with the athlete 120. Such sports information may include a sport in which the athlete 120 is involved 120, a position of the athlete 120 with respect to the sport, a jersey number, one or more sports memberships (e.g., to a particular sports team, sports program, and/or sports organization), and/or other sports details associated with the prospective athlete 120. Further, the prospective athlete 120 may be prompted to provide athlete profile data that includes media data (e.g., picture data, video data, audio data, and/or the like). Such media data may correspond to a profile picture, one or more pictures of the prospective athlete 120 participating in one or more athletics competitions, one or more videos of the prospective athlete 120 participating in one or more athletics competitions, and/or the like.

After the prospective athlete 120 provides the athlete profile data to the computing device 121 (e.g., via the application), the computing device 121 may then transmit the athlete profile data to the recruitment platform 110. After receiving the athlete profile data, the recruitment platform 110 may store the data in the one or more databases mentioned herein. The recruitment platform 110 may then generate an athlete profile for the prospective athlete 120 based on the athlete profile data. The platform 110 may store data corresponding to the athlete profile in the one or more databases, thereby completing the athlete registration process for the prospective athlete 120.

Once the athlete registration process has been completed, the recruitment platform 110 may be able to generate athlete profile visualization data for the prospective athlete 120 using the athlete profile data. In particular, the athlete profile visualization data can be used to generate and display an athlete profile interface, where the displayed athlete profile interface may be a displayed version of the athlete profile. The recruitment platform 110 may transmit the athlete profile visualization data for the prospective athlete 120 to a computing device (e.g., the computing device 151). The computing device may then be able to generate and display the athlete profile interface corresponding to the prospective athlete 120, where the interface may include the biographical information, the sports information, and/or the media data provided by the prospective athlete 120. In some implementations, the recruiting platform 110 may generate the athlete profile interface as described above and then provide the athlete profile interface via a publicly accessible profile webpage associated with the prospective athlete 120, such as through a website associated with the platform 110.

In one implementation, the athlete profile data may also include event statistics data collected and/or recorded for the prospective athlete 120 with respect to one or more athletics competitions. The event statistics data may be similar to the event statistics data described above. In particular, event statistics data may refer to any type of data that can be collected and/or recorded for a prospective athlete participating in a sport, where the data may correspond to one or more statistical categories relating to the sport. In addition, the event statistics data may also correspond to one or more statistical categories that relate to a specific position (e.g., football quarterback) associated with the prospective athlete 120 during the one or more athletics competitions. As described later, the event statistics data may be determined based on event tracking data received from the statistician 140.

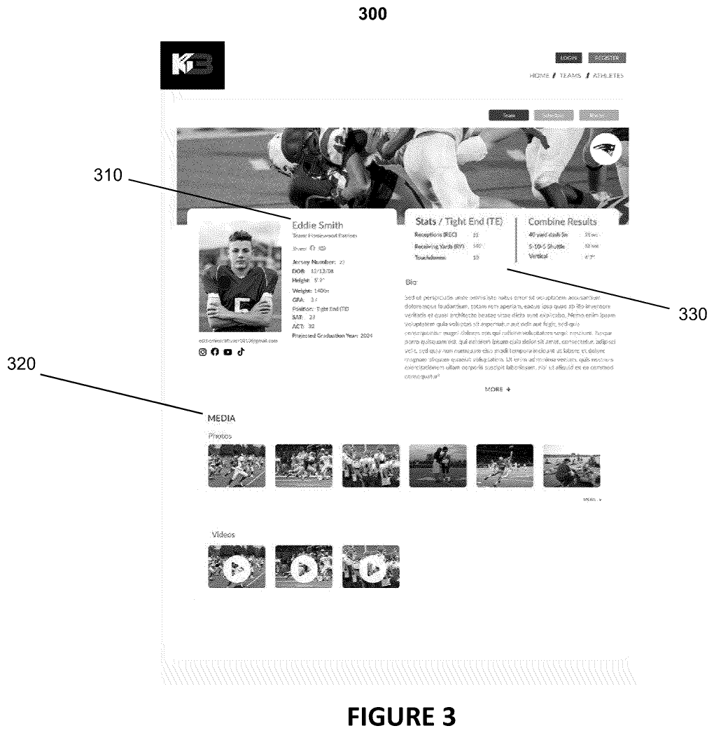

FIG. 3 illustrates a graphical interface 300 in accordance with implementations of various techniques described herein, where a computing device may be configured to display the graphical interface 300. As shown, the graphical interface 300 may correspond to the athlete profile interface for the prospective athlete 120 where the graphical interface 300 may include the biographical information, the sports information, and/or the media data provided by the prospective athlete 120. For example, section 310 of the graphical interface 300 includes at least a portion of both the biographical information and the sports information. In addition, section 320 includes hyperlinks to media files associated with the media data. Further, section 330 includes information pertaining to the event statistics data for the prospective athlete 120.

### C. Statistician Registration

Before the recruitment platform 110 can be used to facilitate an assessment and/or a recruitment of a prospective athlete 120, the statistician 140 may initially need to complete a statistician registration process with the platform 110. To do so, prior to starting the statistician registration process, the statistician 140 may use the computing device 141 to download, install, and/or activate an application associated with the platform 110. As noted above, the entity operating and/or providing the platform 110 may provide and/or host the application. Via the application, the statistician 140 may use his or her computing device 141 to communicate with the platform 110 via the one or more networks 102. In one implementation, the application may be a specialized application associated with the recruitment platform 110 that is designed specifically for statisticians. Such an application may be referred to herein as a statistician application for the platform 110. In another implementation, the application may be the sports application mentioned above.

Further, while the implementations below are discussed in terms of an application installed on the computing device 141, those skilled in the art will understand that other implementations may be applicable as well. For example, the statistician 140 may use a web browser installed on the computing device 141 to communicate with the recruitment platform 110 via the one or more networks 102. In particular, the entity operating and/or providing the recruitment platform 110 may provide and/or host a web portal through which the statistician 140 may access the platform 110. In one implementation, the web portal may be the main portal mentioned above. In another implementation, the web portal may be a specialized web portal that is designed specifically for statisticians. Such a web portal may be referred to herein as a statisticians portal for the platform 110.

After the application has been downloaded, installed, and/or activated on the computing device 141, the statistician 140 may begin the registration process. In particular, the computing device 141 may, via the application, display a prompt indicating that the statistician 140 is to provide statistician profile data for the statistician 140. The statistician 140 may then provide the statistician profile data to the application via one or more input devices of the computing device 141. In one implementation, the statistician 140 may be prompted to provide statistician profile data that includes data corresponding to a username, a password, and/or the like for the statistician 140. In another implementation, the statistician 140 may be prompted to provide statistician profile data that includes data corresponding to biographical information associated with the statistician 140. Such biographical information may include a full name, a location, current occupation, employer information, one or more sports affiliations (e.g., assigned to a particular sports team, sports program, and/or sports organization), a professional history, contact information (e.g., phone number, email address, etc.), and/or other details associated with the statistician 140. In some implementations, the location for the statistician 140 may be determined using the computing device 141 in conjunction with the one or more satellite navigation systems mentioned above.

After the statistician 140 provides the statistician profile data to the computing device 141 (e.g., via the application), the computing device 141 may then transmit the statistician profile data to the recruitment platform 110. After receiving the statistician profile data, the recruitment platform 110 may store the data in the one or more databases mentioned herein. The recruitment platform 110 may then generate a statistician profile for the statistician 140 based on the statistician profile data. The platform 110 may store data corresponding to the statistician profile in the one or more databases, thereby completing the statistician registration process for the statistician 140.

Once the statistician registration process has been completed, the recruitment platform 110 may be able to generate statistician profile visualization data for the statistician 140 using the statistician profile data. In particular, the statistician profile visualization data can be used to generate and display a statistician profile interface, where the displayed statistician profile interface may be a displayed version of the statistician profile. For example, the recruitment platform 110 may transmit the statistician profile visualization data for the statistician 140 to a computing device (e.g., the computing device 131). The computing device may then be able to generate and display the statistician profile interface corresponding to the statistician 140, where the interface may include the biographical information provided by the statistician 140.

### D. Evaluator Registration

Before the recruitment platform 110 can be used to facilitate an assessment and/or a recruitment of a prospective athlete 120, the evaluator 150 may initially need to complete an evaluator registration process with the platform 110. To do so, prior to starting the evaluator registration process, the evaluator 150 may use the computing device 151 to download, install, and/or activate an application associated with the platform 110. As noted above, the entity operating and/or providing the platform 110 may provide and/or host the application. Via the application, the evaluator 150 may use his or her computing device 151 to communicate with the platform 110 via the one or more networks 102. In one implementation, the application may be the sports application mentioned above. In another implementation, the application may be a specialized application associated with the recruitment platform 110 that is designed specifically for evaluators. Such an application may be referred to herein as an evaluators application for the platform 110.

Further, while the implementations below are discussed in terms of an application installed on the computing device 151, those skilled in the art will understand that other implementations may be applicable, as well. For example, the evaluator 150 may use a web browser installed on the computing device 151 to communicate with the recruitment platform 110 via the one or more networks 102. In particular, the entity operating and/or providing the recruitment platform 110 may provide and/or host a web portal through which the evaluator 150 may access the platform 110. In one implementation, the web portal may be the main portal mentioned above. In another implementation, the web portal may be a specialized web portal that is designed specifically for evaluators. Such a web portal may be referred to herein as an evaluators portal for the platform 110.

After the application has been downloaded, installed, and/or activated on the computing device 151, the evaluator 150 may begin the registration process. In particular, the computing device 151 may, via the application, display a prompt indicating that the evaluator 150 is to provide evaluator profile data for the evaluator 150. The evaluator 150 may then provide the evaluator profile data to the application via one or more input devices of the computing device 151. In one implementation, the evaluator 150 may be prompted to provide evaluator profile data that includes data corresponding to a username, a password, and/or the like for the evaluator 150. In another implementation, the evaluator 150 may be prompted to provide evaluator profile data that includes data corresponding to biographical information associated with the evaluator 150. Such biographical information may include a full name, a location, a current occupation (e.g., coach or recruiter for a particular sports team, sports program, or sports organization), employer information, a professional history, contact information (e.g., phone number, email address, etc.), and/or other details associated with the evaluator 150. In some implementations, the location for the evaluator 150 may be determined using the computing device 151 in conjunction with the one or more satellite navigation systems mentioned above. In addition, the evaluator 150 may be prompted to provide evaluator profile data that includes data corresponding to recruiting information associated with the evaluator 150. Such recruiting information may include one or more sports under assessment by the evaluator 150, one or more positions under assessment by the evaluator 150, and/or the like.

After the evaluator 150 provides the evaluator profile data to the computing device 151 (e.g., via the application), the computing device 151 may then transmit the evaluator profile data to the recruitment platform 110. After receiving the evaluator profile data, the recruitment platform 110 may store the data in the one or more databases mentioned herein. The recruitment platform 110 may then generate an evaluator profile for the evaluator 150 based on the evaluator profile data. The platform 110 may store data corresponding to the evaluator profile in the one or more databases, thereby completing the evaluator registration process for the evaluator 150.

Once the evaluator registration process has been completed, the recruitment platform 110 may be able to generate evaluator profile visualization data for the evaluator 150 using the evaluator profile data. In particular, the evaluator profile visualization data can be used to generate and display an evaluator profile interface, where the displayed evaluator profile interface may be a displayed version of the evaluator profile. For example, the recruitment platform 110 may transmit the evaluator profile visualization data for the evaluator 150 to a computing device (e.g., the computing device 121). The computing device may then be able to generate and display the evaluator profile interface corresponding to the evaluator 150, where the interface may include the biographical information and the recruiting information provided by the evaluator 150.

### E. Event Tracking Data

As noted above, the evaluator 150 may assess a prospective athlete 120 based on any number of factors, including the prospective athlete's 120 performance during one or more athletics competitions. To assess the prospective athlete's 120 performance, the evaluator 150 may analyze event statistics data recorded for the prospective athlete 120 with respect to the one or more athletics competitions. Thus, the evaluation and/or recruitment of the prospective athlete 120 may be facilitated by having access to accurate event statistics data recorded for the athlete 120 during one or more athletics competitions.

In various implementations described herein, the recruiting platform 110 may be used to determine event statistics data for an athletics competition associated with the sports coach 130 and the prospective athletes 120 based on event tracking data, where the event tracking data is provided by the statistician 140. The athletics competition may be similar to the athletics competition described above. In particular, the athletics competition may be any form of contest that involves athletes and/or groups of athletes (e.g., sports teams) competing amongst each other in at least one sport. Examples of an athletics competition may include, but are not limited to, the following: a game, a scrimmage, a practice, a tournament, a combine, an invitational event, an exhibition, a match, and/or the like. In a further implementation, the prospective athletes 120 of FIG. 1 may be a subset of the total athletes who are participating in the athletics competition. In addition, as explained above, the sports coach 130 may be an individual who is in a position to coach, teach, instruct, manage, and/or lead these prospective athletes 120 with respect to the athletics competition. As also noted above, in one or more databases of the platform 110, the prospective athletes 120 of FIG. 1 may be assigned to a sports team associated with the coach profile of the sports coach 130.

In one implementation, and as explained above, the statistician 140 may attend and observe the athletics competition associated with the sports coach 130 and these prospective athletes 120. The statistician 140 may attend and observe the athletics competition as a result of having been assigned to the sports team affiliated with the sports coach 130 and the prospective athletes 120 of FIG. 1, which may be indicated in the statistician profile for the statistician 140. In some implementations, the statistician 140 may be affiliated with the sports coach 130 and/or the prospective athletes 120, such that the statistician 140 may be a member of the same sports team, sports program, and/or sports organization. In addition, the statistician 140 may be able to determine which athletics competitions to attend based on the schedule of athletics competitions indicated by the coach profile interface for the sports coach 130.

While attending the athletics competition, the statistician 140 may use the computing device 141 (e.g., via its application) to collect and/or record event tracking data for the athletics competition. In one implementation, the application may be the statistician application described above. The event tracking data collected and/or recorded by the statistician 140 via the application may correspond to one or more events that occur during the athletics competition. These one or more events may include any notable and/or significant occurrences, plays, activities, and/or the like that happen during the athletics competition. In a further implementation, the recruitment platform 110 and/or application of the computing device 141 may designate what is considered to be an event for purposes of collecting and recording event tracking data. Moreover, what is considered to be such an event may differ based on the sport involved in the athletics competition. For example, if the athletics competition is a college football game, then the events may include every play or down, every penalty, every stoppage in time, every substitution, and/or the like that occur during the game. In another example, if the athletics competition is a high school basketball game, then the events may include every team possession, every field goal attempt, every free throw attempt, every foul, every stoppage in play, every turnover, every rebound, every substitution, every block, and/or the like that occur during the game.

In some implementations, as noted above, the event tracking data may correspond to a log of events that occurred during the athletics competition, where the log may include a data entry for each event. In one such implementation, the statistician 140 may collect and/or record this log of events during the course of the athletics competition, such that the event tracking data may be collected and/or recorded in real-time or near real-time for the athletics competition.

In addition, each data entry provided by the statistician 140 for the event may include data corresponding to a contribution by one or more athletes to the event. For example, the event tracking data for a college football game may include a data entry provided by the statistician 140 for a single play, where the data entry indicates a thirty yard pass from prospective athlete #16 to prospective athlete #80, a missed tackle by opposing player #41, and a tackle made by opposing player #50. In another example, the event tracking data for a high school basketball game may include a data entry provided by the statistician 140 for Team A taking possession at Time 1, a three-point field goal made by prospective athlete #23 at Time 2, and an assist by prospective athlete #10. In a further example, the data entry may indicate a location on the basketball court (e.g., left corner) from where the three-point field goal was made by prospective athlete #23. In a further implementation, the statistician 140 may collect and/or record event tracking data for only the athletes participating in the athletics competition who are also registered with the recruiting platform 110. In yet another implementation, the statistician 140 may collect and/or record event tracking data for only those athletes (e.g., the prospective athletes 120 of FIG. 1) to whom the statistician 140 has been assigned with respect to the recruiting platform 110.

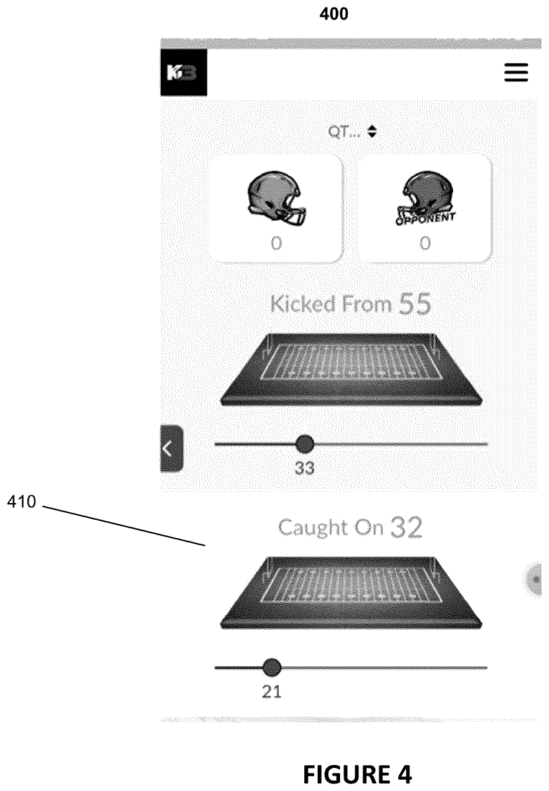

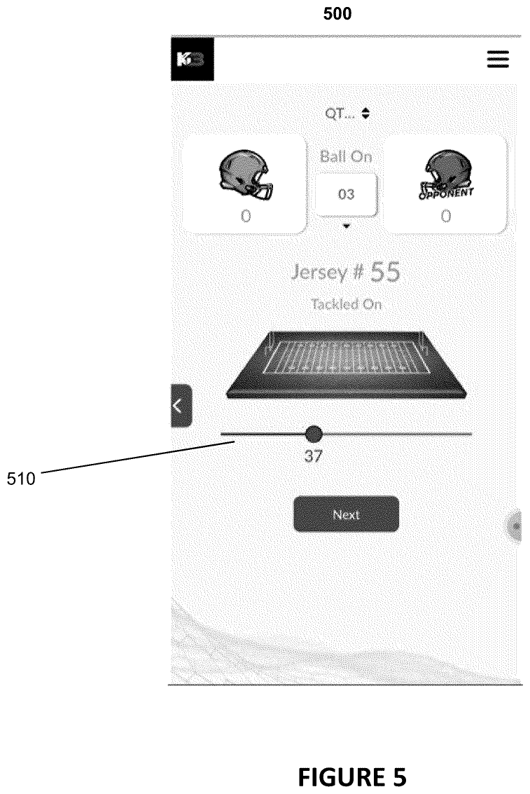

The statistician 140 may provide the event tracking data to the application via one or more input devices of the computing device 141. In one implementation, the statistician 140 may provide the event tracking data via a touchscreen graphical interface rendered via the application by the computing device 141, where the interface may be designed for a particular sport and/or athletics competition. For example, FIG. 4 illustrates a graphical interface 400 in accordance with implementations of various techniques described herein, where the computing device 141 may be configured to display the graphical interface 400 via a touchscreen. As shown, the graphical interface 400 corresponds to a football game. In particular, the interface 400 is configured to allow the statistician 140 to provide event tracking data for a kickoff attempt, where such data may correspond to yards kicked, an identification of the kicker, kickoff return yards, and an identification of the kickoff returner. For example, the statistician 140 may provide the yards kicked for the event by adjusting the virtual dial 410 of the graphical interface 400. Similarly, FIG. 5 illustrates a graphical interface 500 in accordance with implementations of various techniques described herein, where the computing device 141 may be configured to display the graphical interface 500 via a touchscreen. As shown, the graphical interface 500 corresponds to a football game. In particular, the interface 500 is configured to allow the statistician 140 to provide event tracking data for a rushing attempt, where such data may include rushing yardage, an identification of the rusher, and an identification of the tackler. For example, the statistician 140 may provide the rushing yardage for the event by adjusting the virtual dial 510 of the graphical interface 500.

Once the event tracking data has been submitted to the application by the statistician 140, the event tracking data cannot be altered, changed, or otherwise manipulated by the statistician 140. In one implementation, after the statistician 140 provides the event tracking data for an event to the computing device 141 (e.g., via the application), the computing device 141 may store the event tracking data in one or more databases located in memory (e.g., one or more computer-readable storage media) associated with the computing device 141.

In yet another implementation, the computing device 141 of the statistician 140 may be configured to record and/or capture media data (e.g., picture data, video data, audio data, and/or the like) during the athletics competition. The computing device 141 (i.e., via the application) may transmit the media data to the recruitment platform 110, such that the platform 110 may be configured to generate and/or determine the event tracking data for the athletics competition based on the received media data.

### F. Event Statistics Data

In one implementation, after the statistician 140 provides the event tracking data for the athletics competition to the computing device 141 (e.g., via the application), the computing device 141 may transmit the entirety of the event tracking data for the athletics competition to the recruitment platform 110 once the athletics competition has concluded. In such an implementation, at least a portion of the event tracking data may be retrieved from one or more databases of the computing device 141 prior to transmitting the event tracking data to the platform 110.

After receiving the event tracking data from the computing device 141, the recruitment platform 110 may store the event tracking data in the one or more databases of the platform 110. In addition, the recruitment platform 110 may then determine event statistics data for the athletics competition based on the event tracking data. As noted above, such event statistics data may refer to any type of data that can be collected and/or recorded for the athletics competition, where the data may correspond to one or more statistical categories relating to the sport. Thus, for each data entry of the event tracking data, the platform 110 may determine if a prospective athlete 120 performed in a manner such that the athlete 120 produced one or more data values with respect to the one or more statistical categories. If so, then the platform 110 may determine and/or extract the one or more data values for each prospective athlete 120 for each data entry for these statistical categories. Then, based on all data entries of the event tracking data, the platform 110 may determine one or more total data values (e.g., summed data values) for each prospective athlete 120 with respect to the one or more statistical categories. These determined total data values may correspond to the event statistics data for the athlete 120 that were collected and/or recorded for the athletics competition.

For example, if the athletics competition was a college football game, then the platform 110 may determine the event statistics data that were collected and/or recorded for each prospective athlete 120 by determining one or more total data values with respect to passing yards, receiving yards, tackles, missed tackles, and/or the like that were collected and/or recorded for each prospective athlete 120. In one implementation, the platform 110 may perform such a determination of the event statistics data only for those athletes (e.g., the prospective athletes 120 of FIG. 1) to whom the statistician 140 has been assigned with respect to the recruiting platform 110.

After determining the event statistics data for each prospective athlete 120 during the athletics competition, the recruitment platform 110 may update the athlete profile data for each prospective athlete 120 based on the determined event statistics data. As noted above, the athlete profile data may also include event statistics data collected and/or recorded for the prospective athlete 120 with respect to one or more athletics competitions. Thus, the athlete profile data for each prospective athlete 120 may be updated to incorporate the newly determined event statistics data for the athlete. For example, a prospective athlete 120 may be a high school quarterback who participated in a just-concluded high school football game. Based on the event tracking data received from the statistician 140 for the game, the recruiting platform 110 may determine the event statistics data for the athlete 120, where event statistics data may reflect that the athlete 120 threw five touchdown passes during the game. Accordingly, the athlete profile data for the athlete 120 may be updated to reflect an increase in career passing touchdowns by five touchdowns.

Upon updating the athlete profile data for a prospective athlete 120, the recruitment platform 110 may be able to generate athlete profile visualization data for the prospective athlete 120 using the updated athlete profile data. As noted above, the athlete profile visualization data can be used to generate and display an athlete profile interface, where the displayed athlete profile interface may be a displayed version of the athlete profile. The recruitment platform 110 may transmit the athlete profile visualization data for the prospective athlete 120 to a computing device (e.g., the computing device 151). The computing device may then be able to generate and display the athlete profile interface corresponding to the prospective athlete 120. In some implementations, the recruiting platform 110 may generate the athlete profile interface and then provide the athlete profile interface via a publicly accessible profile webpage associated with the prospective athlete 120, such as through a website associated with the platform 110.

In another implementation, after the statistician 140 provides the event tracking data for an event that occurred during the athletics competition to the computing device 141 (e.g., via the application), the computing device 141 may transmit the event tracking data for the event to the recruitment platform 110. In particular, the computing device 141 may transmit the event tracking data for the event to the recruitment platform 110 once it has been provided by the statistician 140, such that the event tracking data may be transmitted to the platform 110 in real-time or near real-time. After receiving the event tracking data from the computing device 141, the recruitment platform 110 may store the event tracking data in the one or more databases of the platform 110. In addition, the recruitment platform 110 may determine event statistics data for the athletics competition based on the event tracking data. Specifically, for the data entry, the platform 110 may determine and/or extract one or more data values with respect to one or more statistical categories for each prospective athlete 120. These data values may correspond to the event statistics data for each athlete 120 with respect to the received data entry.

After determining the event statistics data for each prospective athlete 120 for the received data entry (i.e., the event tracking data), the recruitment platform 110 may update the athlete profile data for each prospective athlete 120 based on the determined event statistics data. In particular, the athlete profile data for each prospective athlete 120 may be updated to incorporate the newly determined event statistics data for the athlete. In some implementations, the recruitment platform 110 may update the athlete profile data for each prospective athlete 120 in real-time or near real-time. Upon updating the athlete profile data for a prospective athlete 120, the recruitment platform 110 may be able to generate athlete profile visualization data for the prospective athlete 120 using the updated athlete profile data. As noted above, the athlete profile visualization data can be used to generate and display an athlete profile interface, where the displayed athlete profile interface may be a displayed version of the athlete profile. The recruitment platform 110 may transmit the athlete profile visualization data for the prospective athlete 120 to a computing device (e.g., the computing device 151). The computing device may then be able to generate and display the athlete profile interface corresponding to the prospective athlete 120, where the athlete profile interface may be generated and displayed based on the updated athlete profile data in real-time or near real-time. In some implementations, the recruiting platform 110 may generate the athlete profile interface and then provide the athlete profile interface via a publicly accessible profile webpage associated with the prospective athlete 120, such as through a website associated with the platform 110.

In yet another implementation, the computing device 141 of the statistician 140, rather than the platform 110, may be configured to determine the event statistics data in a similar manner as described above for the platform 110. In such an implementation, the computing device 141 may transmit the event statistics data for each prospective athlete 120 to the recruitment platform 110. The recruitment platform 110 may store the event statistics data in the one or more databases of the platform 110. In addition, the platform 110 may then use the event statistics data to update the athlete profile data for each prospective athlete 120 based on the received event statistics data. In some implementations, the recruitment platform 110 may be able to update the athlete profile data for each prospective athlete 120 in real-time or near real-time based on the event statistics data.

Upon updating the athlete profile data for a prospective athlete 120, the recruitment platform 110 may be able to generate athlete profile visualization data for the prospective athlete 120 using the updated athlete profile data. As noted above, the athlete profile visualization data can be used to generate and display an athlete profile interface, where the displayed athlete profile interface may be a displayed version of the athlete profile. The recruitment platform 110 may transmit the athlete profile visualization data for the prospective athlete 120 to a computing device (e.g., the computing device 151). The computing device may then be able to generate and display the athlete profile interface corresponding to the prospective athlete 120, where the athlete profile interface may be generated and displayed based on the updated athlete profile data in real-time or near real-time. In some implementations, the recruiting platform 110 may generate the athlete profile interface and then provide the athlete profile interface via a publicly accessible profile webpage associated with the prospective athlete 120, such as through a website associated with the platform 110.

In another implementation, the computing device 141 of the statistician 140 may be configured to record and/or capture media data (e.g., picture data, video data, audio data, and/or the like) during the athletics competition. The computing device 141 (i.e., via the application) may transmit the media data to the recruitment platform 110, such that the platform 110 may include the media data in the coach profile of the sports coach 130, an athlete profile of a prospective athlete 120, and/or the like. In a further implementation, the computing device 141 (i.e., via the application) may transmit the media data to the recruitment platform 110 in real-time or near real-time.

In a further implementation, upon obtaining the event tracking data and/or the event statistics data as described above, the recruitment platform 110 may generate a real-time or near real-time visual representation (e.g., symbols, markers, etc.) of the athletics competition, where the visual representation may be linked to and accessible from the coach profile for the sports coach 130, an athlete profile for a prospective athlete 120, a statistician profile for the statistician 140, and/or the like.

### G. Athlete Assessment

As noted above, the evaluator 150 may assess a prospective athlete 120 based on any number of factors, including the prospective athlete's 120 performance during one or more athletics competitions. To assess the prospective athlete's 120 performance, the evaluator 150 may analyze event statistics data recorded for the prospective athlete 120 with respect to the one or more athletics competitions. Based on this assessment, the evaluator 150 may then be able to determine whether the prospective athlete 120 is to be recruited to join a sports team, sports program, and/or sports organization associated with the evaluator 150.

In one implementation, the evaluator 150 may perform such an assessment by using the recruiting platform 110 to sort and/or rank the event statistics data for all prospective athletes registered with the platform 110. By sorting and/or ranking the event statistics data, the recruitment platform 110 may generate a sorted and/or ranked list of prospective athletes that may be helpful for assessing the athletes. In particular, the evaluator 150 may provide sort input data to the above-mentioned application via one or more input devices of the computing device 151, where the sort input data may indicate criteria for sorting and/or ranking the event statistics data for the prospective athletes associated with the platform 110. Such criteria may correspond to sport types, types of event statistics data, and/or the like.

After the evaluator 150 provides the sort input data to the computing device 151 (e.g., via the application), the computing device 151 may transmit the sort input data to the recruitment platform 110. After receiving the sort input data from the computing device 151, the recruitment platform 110 may perform a sorting operation for the prospective athletes based on the sort input data and the event statistics data. From the sorting operation, the platform 110 may generate sort output data that corresponds to a subset of the event statistics data. In particular, the sort output data may include a sorted and/or ranked list of event statistics data and associated prospective athletes that corresponds to the criteria of the sort input data.

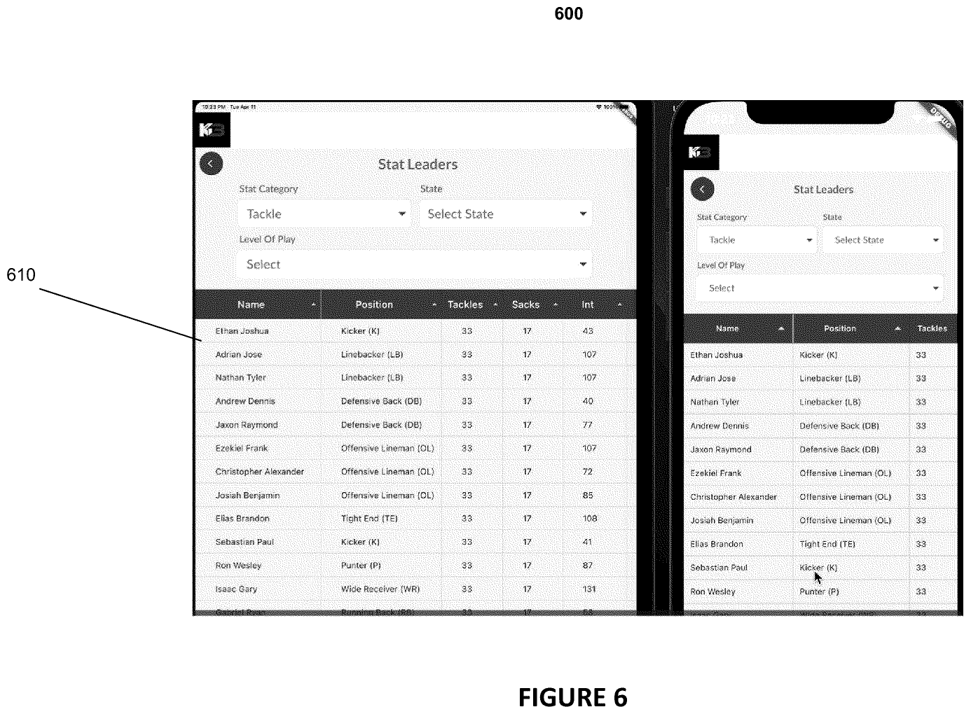

Once the sort output data has been generated, the recruitment platform 110 may be able to generate sort visualization data for the evaluator 150 based on the sort output data. In particular, the sort visualization data can be used to generate and display a sort output interface, where the displayed sort output interface may be a displayed version of the sort output data. The recruitment platform 110 may transmit the sort visualization data to the computing device 151. The computing device 151 may then be able to generate and display the sort output interface for the evaluator 150 based on the sort output data. For example, FIG. 6 illustrates a graphical interface 600 in accordance with implementations of various techniques described herein, where the computing device 151 may be configured to display the graphical interface 600 to the evaluator 150. As shown, the graphical interface 600 may display a sorted and/or ranked list that corresponds to a subset of the event statistics data. In particular, the interface 600 displays a sorted list 610 of football tackles for a group of prospective athletes. While implementations for sorting and/or ranking the event statistics data are described herein with respect to the evaluator 150, those skilled in the art will understand that other parties to the recruitment platform 110, such as a sports coach 130 or an athlete 120, may also utilize the platform 110 in such a manner.

In another implementation, the evaluator 150 may perform an assessment of prospective athletes by using the recruiting platform 110 to search and/or filter the athlete profile data for all prospective athletes registered with the platform 110. In doing so, the recruitment platform 110 may generate a filtered list of prospective athletes that may be helpful for assessing the athletes. In particular, the evaluator 150 may provide search input data to the above-mentioned application via one or more input devices of the computing device 151, where the search input data may indicate criteria for searching and/or filtering the athlete profile data for the prospective athletes associated with the platform 110. Such criteria may correspond to a designated age range, a designated sport, a designated position, a geographic range, a range of academic values, and/or the like.

After the evaluator 150 provides the search input data to the computing device 151 (e.g., via the application), the computing device 151 may transmit the search input data to the recruitment platform 110. After receiving the search input data from the computing device 151, the recruitment platform 110 may perform a searching operation for the prospective athletes based on the search input data and the athlete profile data. From the searching operation, the platform 110 may generate search output data that corresponds to a subset of the athlete profile data. In particular, the search output data may include a filtered list of prospective athletes that corresponds to the criteria of the search input data.

Once the search output data has been generated, the recruitment platform 110 may be able to generate search visualization data for the evaluator 150 based on the search output data. In particular, the search visualization data can be used to generate and display a search output interface, where the displayed search output interface may be a displayed version of the search output data. The recruitment platform 110 may transmit the search visualization data to the computing device 151. The computing device 151 may then be able to generate and display the search output interface for the evaluator 150 based on the search output data.

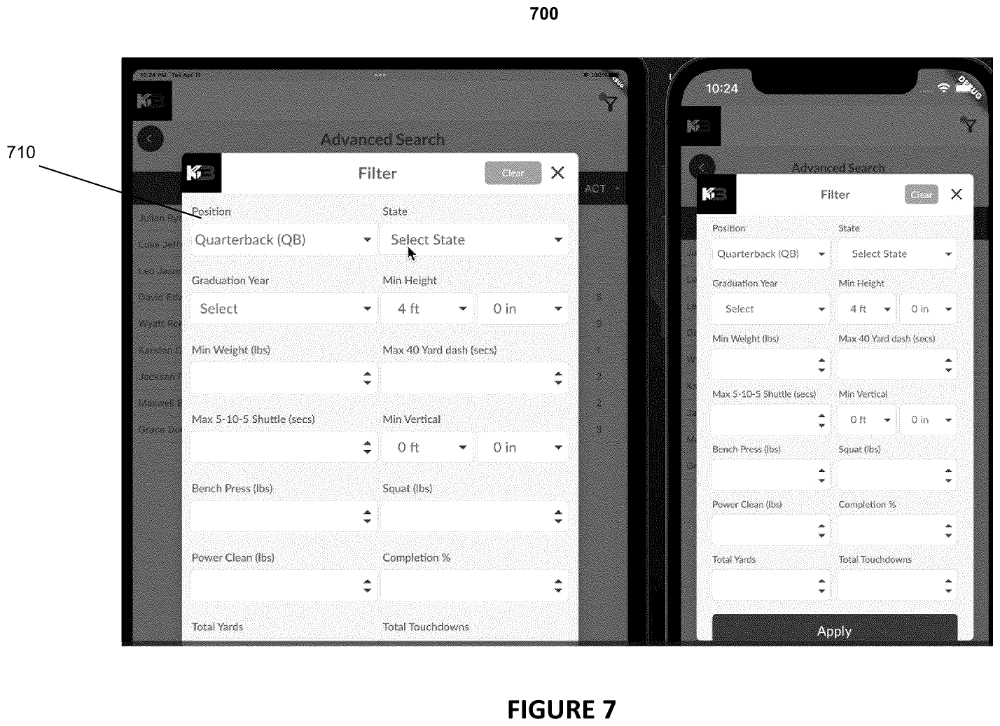

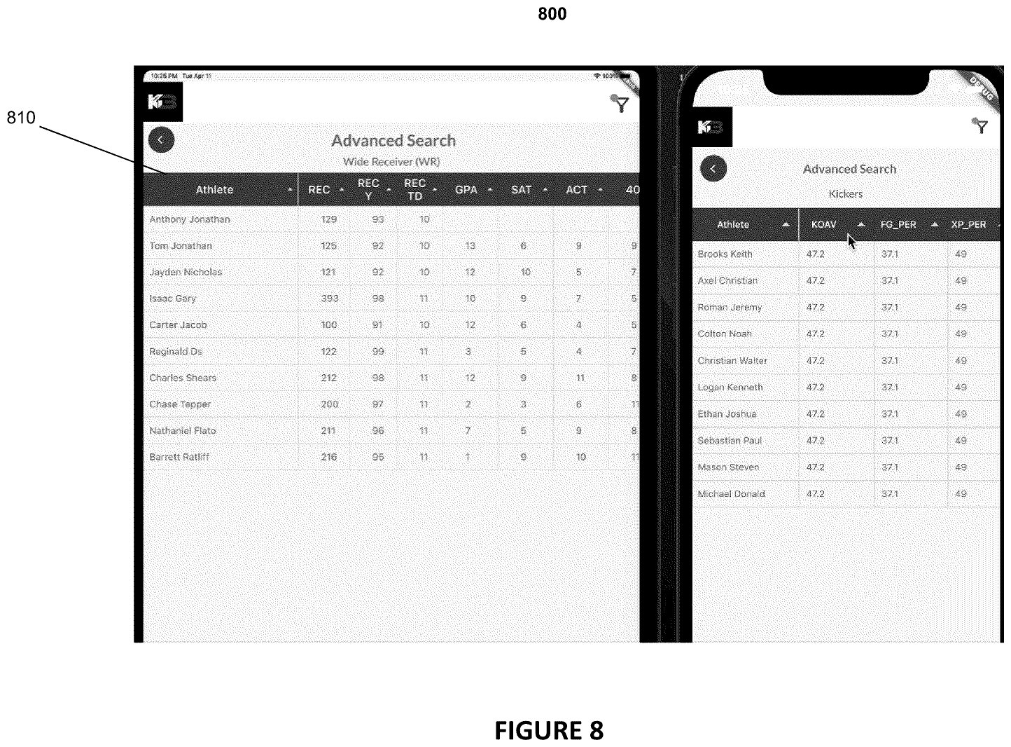

For example, FIG. 7 illustrates a graphical interface 700 in accordance with implementations of various techniques described herein, where the computing device 151 may be configured to display the graphical interface 700 to the evaluator 150. As shown, the graphical interface 700 may include a number of entry fields for providing the search input data from the evaluator 150. In addition, FIG. 8 illustrates a graphical interface 800 in accordance with implementations of various techniques described herein, where the computing device 151 may be configured to display the graphical interface 800 to the evaluator 150. As shown, the graphical interface 800 may correspond to the search output data, including a displayed subset 810 of the prospective athletes that corresponds to the search input data.

Based on the displayed the search output interface, an evaluator 150 may be able to perform an improved assessment of the athletes 120 of the platform 110. The evaluator 150 may then be able to identify potential recruits of the displayed subset of prospective athletes that correspond to the search input data, such as through the use of one or more predetermined thresholds for the search output data. In one implementation, based on this identification and the use of predetermined thresholds, the evaluator 150 may generate one or more watchlists of athletes using the platform 110, such that the platform 110 may track the event statistics data for the listed athletes. In addition, the platform 110 may be configured to generate one or more visual representations that correspond to the search output data, such as by producing one or more simulations of gameplay as performed by the subset of athletes. While implementations for searching and/or filtering the athlete profile data are described herein with respect to the evaluator 150, those skilled in the art will understand that other parties to the recruitment platform 110, such as a sports coach 130 or an athlete 120, may also utilize the platform 110 in such a manner.

In yet another implementation, the evaluator 150 may utilize the computing device 151 (e.g., via the application) to communicate with a prospective athlete 120 via a messaging functionality of the platform 110, where the messaging functionality may correspond to in-app messaging between the evaluator 150 and the athlete 120. In one example, the evaluator 150 may be able to initiate a messaging conversation with the athlete 120, while the athlete 120 may not be allowed to initiate the conversation and may only be able to reply to the evaluator 150.

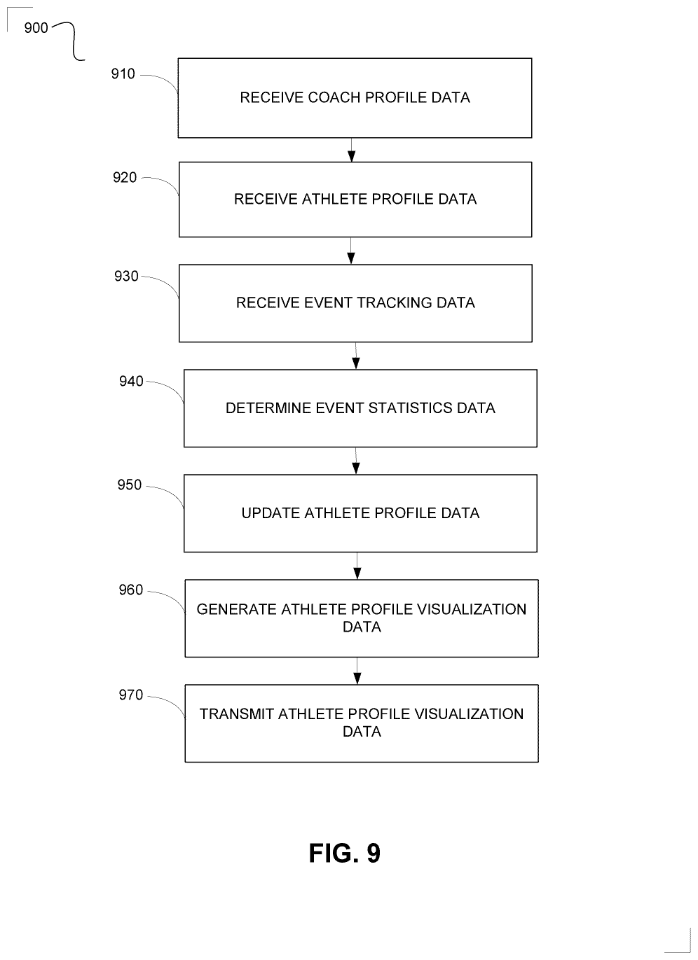

FIG. 9 illustrates a flow diagram of a method 900 for using a recruiting platform in accordance with implementations of various techniques described herein. In one implementation, method 900 may be at least partially performed by one or more computing systems, such as the recruiting platform 110 and/or the computing device 111 discussed above. It should be understood that while method 900 indicates a particular order of execution of operations, in some implementations, certain portions of the operations might be executed in a different order. Further, in some implementations, additional operations or steps may be added to the method 900. Likewise, some operations or steps may be omitted.

At block 910, the recruiting platform may receive coach profile from a sports coach associated with one or more athletes, where the coach profile data corresponds to the sports coach. As noted above, the recruitment platform may generate a coach profile for the sports coach based on the coach profile data.

At block 920, the recruiting platform may receive athlete profile data from the one or more athletes, where the athlete profile data corresponds to the one or more athletes. As noted above, the recruiting platform may generate an athlete profile for a prospective athlete based on the athlete profile data.

At block 930, the recruiting platform may receive event tracking data from a statistician for an athletics competition associated with the sports coach and the one or more athletes, where the tracking data corresponds to events that occur during the athletics competition. As noted above, the event tracking data may correspond to a log of events that occurred during the athletics competition, where the log may include a data entry for each event. In one implementation, the statistician may collect and/or record this log of events during the course of the athletics competition, such that the event tracking data may be collected and/or recorded in real-time or near real-time for the athletics competition.

At block 940, the recruiting platform may determine event statistics data for the athletics competition based on the tracking data, where the event statistics data for a respective athlete corresponds to one or more statistics associated with the respective athlete during the athletics competition. As noted above, event statistics data may refer to any type of data that can be collected and/or recorded for the athletics competition, where the data may correspond to one or more statistical categories relating to a sport. Thus, for each data entry of the event tracking data, the platform may determine if a prospective athlete performed in a manner such that the athlete produced one or more data values with respect to the one or more statistical categories.

At block 950, the recruiting platform may update the athlete profile data for the one or more athletes based on the event statistics data. At block 960, the recruiting platform may generate athlete profile visualization data for the one or more athletes based on the updated athlete profile data. In particular, the athlete profile visualization data may be configured for use in generating one or more athlete profile interfaces for a computing device. At block 970, the recruiting platform may transmit the athlete profile visualization data to the computing device.

Accordingly, in view of the implementations discussed above with respect to FIGS. 1-9, the recruiting platform may be used to facilitate an evaluation and/or a recruitment of one or more prospective athletes. As noted above, using event statistics data, an evaluator may be able to appraise a level of performance by the prospective athletes during the one or more athletics competitions. Based on this appraisal, the evaluator may then be able to determine whether the prospective athlete is to be recruited to join a sports team, sports program, and/or sports organization associated with the evaluator. By using a statistician as described herein, the recruiting platform may be used to generate more accurate and reliable event tracking data and event statistics data for the one or more athletics competitions. In turn, the evaluation and/or recruitment of a prospective athlete may be improved by having access to more accurate and reliable event statistics data recorded for the athlete.

### III. Computing System

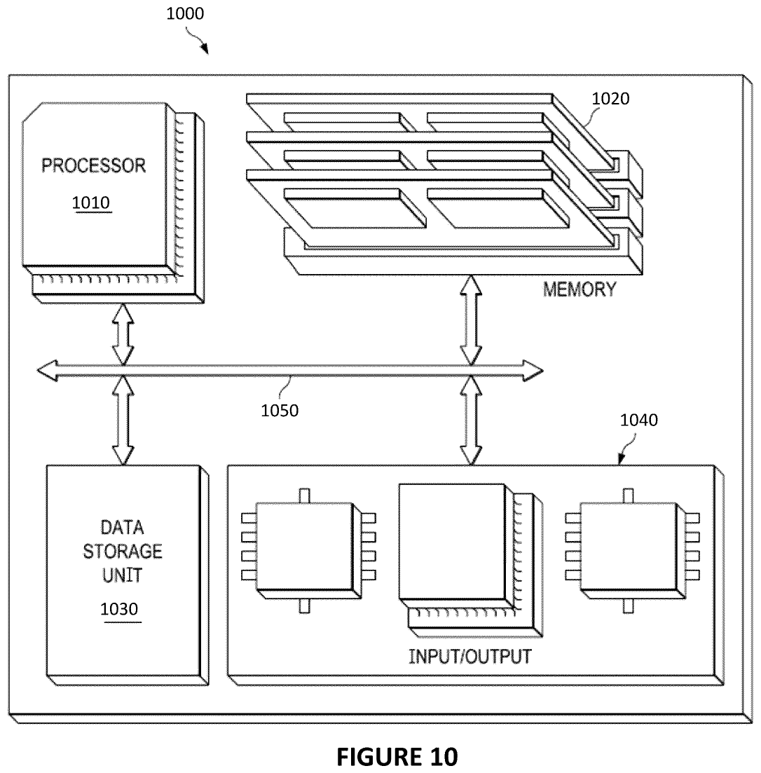

FIG. 10 illustrates a block diagram of a hardware configuration 1000 in which one or more various technologies described herein may be incorporated and practiced. The hardware configuration 1000 can be used to implement the one or more computing systems discussed above, such as the devices 111, 121, 131, 141, and 151. The hardware configuration 1000 can include a processor 1010, a memory 1020, a storage device 1010, and an input/output device 1040. Each of the components 1010, 1020, 1030, and 1040 can, for example, be interconnected using a system bus 1050. The processor 1010 can be capable of processing instructions for execution within the hardware configuration 1000. In one implementation, the processor 1010 can be a single-threaded processor. In another implementation, the processor 1010 can be a multi-threaded processor. The processor 1010 can be capable of processing instructions stored in the memory 1020 or on the storage device 1030.

The memory 1020 can store information within the hardware configuration 1000. In one implementation, the memory 1020 can be a computer-readable medium. In one implementation, the memory 1020 can be a volatile memory unit. In another implementation, the memory 1020 can be a non-volatile memory unit.

In some implementations, the storage device 1030 can be capable of providing mass storage for the hardware configuration 1000. In one implementation, the storage device 1030 can be a computer-readable medium. In various different implementations, the storage device 1030 can, for example, include a hard disk device/drive, an optical disk device, flash memory or some other large capacity storage device. In other implementations, the storage device 1030 can be a device external to the hardware configuration 1000. Various implementations for the memory 1020 and/or the storage device 1030 are further discussed below.

The input/output device 1040 can provide input/output operations for the hardware configuration 1000. In one implementation, the input/output device 1040 can include one or more display system interfaces, sensors and/or data transfer ports.

The subject matter of this disclosure, and/or components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output thereby tying the process to a particular machine, e.g., a machine programmed to perform the processes described herein. The processes and logic flows can also be performed by, and apparatus can also be implemented as, special purpose logic circuitry, e.g., an FPGA (field programmable gate array) or an ASIC (application specific integrated circuit).

Computer readable media (e.g., memory 1020 and/or the storage device 1030) suitable for storing computer program instructions and data may include all forms of non-volatile memory, media, and memory devices, including, by way of example, any semiconductor memory devices (e.g., EPROM, EEPROM, solid state memory devices, and flash memory devices); any magnetic disks (e.g., internal hard disks or removable disks); any magneto optical disks; and any CD-ROM and DVD-ROM disks. The processor and the memory can be supplemented by, or incorporated in, special purpose logic circuitry.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method, comprising:
receiving, by a recruitment platform, coach profile data from a sports coach associated with one or more athletes, wherein the coach profile data corresponds to the sports coach;
receiving, by the recruitment platform, athlete profile data from the one or more athletes, wherein the athlete profile data corresponds to the one or more athletes;
receiving, by the recruitment platform, event tracking data from a statistician for an athletics competition associated with the sports coach and the one or more athletes, wherein the event tracking data corresponds to events that occur during the athletics competition;
determining, by the recruitment platform, event statistics data for the athletics competition based on the event tracking data, wherein the event statistics data for a respective athlete corresponds to one or more statistics associated with the respective athlete during the athletics competition;
updating, by the recruitment platform, the athlete profile data for the one or more athletes based on the event statistics data;
generating, by the recruitment platform, athlete profile visualization data for the one or more athletes based on the updated athlete profile data, wherein the athlete profile visualization data is configured for use in generating one or more athlete profile interfaces for a computing device; and
transmitting, by the recruitment platform, the athlete profile visualization data to the computing device.

2. The method of claim 1, wherein the tracking data comprises a log of the events that occur during the athletics competition.

3. The method of claim 2, wherein the events comprise statistical events that occur during the athletics competition.

4. The method of claim 2, wherein the log of the events is provided by the statistician in real-time or near real-time.

5. The method of claim 1, wherein transmitting, by the recruitment platform, the athlete profile visualization data comprises transmitting, by the recruitment platform, the athlete profile visualization data for the respective athlete to the computing device.

6. The method of claim 1, wherein the one or more statistics associated with the respective athlete during the athletics competition comprises one or more statistics accumulated by the respective athlete during the athletics competition.

7. The method of claim 1, wherein the coach profile data is received from the sports coach using a first application associated with the recruiting platform, wherein the event tracking data is received from the statistician using a second application, and wherein the first application and the second application are different.

8. A recruiting platform, comprising:
one or more processors; and
a memory comprising a plurality of program instructions which, when executed by the one or more processors, cause the one or more processors to:
receive coach profile data from a sports coach associated with one or more athletes, wherein the coach profile data corresponds to the sports coach;
receive athlete profile data from the one or more athletes, wherein the athlete profile data corresponds to the one or more athletes;
receive event tracking data from a statistician for an athletics competition associated with the sports coach and the one or more athletes, wherein the event tracking data corresponds to events that occur during the athletics competition;
determine event statistics data for the athletics competition based on the event tracking data, wherein the event statistics data for a respective athlete corresponds to one or more statistics associated with the respective athlete during the athletics competition;
update the athlete profile data for the one or more athletes based on the event statistics data;
generate athlete profile visualization data for the one or more athletes based on the updated athlete profile data, wherein the athlete profile visualization data is configured for use in generating one or more athlete profile interfaces for a computing device; and
transmit the athlete profile visualization data to the computing device.

9. The system of claim 8, wherein the tracking data comprises a log of the events that occur during the athletics competition.

10. The system of claim 9, wherein the events comprise statistical events that occur during the athletics competition.

11. The system of claim 9, wherein the log of the events is provided by the statistician in real-time or near real-time.

12. The system of claim 8, wherein transmitting, by the recruitment platform, the athlete profile visualization data comprises transmitting, by the recruitment platform, the athlete profile visualization data for the respective athlete to the computing device.

13. The system of claim 8, wherein the one or more statistics associated with the respective athlete during the athletics competition comprises one or more statistics accumulated by the respective athlete during the athletics competition.

14. The system of claim 8, wherein the coach profile data is received from the sports coach using a first application associated with the recruiting platform, wherein the event tracking data is received from the statistician using a second application, and wherein the first application and the second application are different.

15. A non-transitory computer-readable medium having stored thereon a plurality of computer-executable instructions which, when executed by a computer, cause the computer to:
receive, by a recruitment platform, coach profile data from a sports coach associated with one or more athletes, wherein the coach profile data corresponds to the sports coach;
receive, by the recruitment platform, athlete profile data from the one or more athletes, wherein the athlete profile data corresponds to the one or more athletes;
receive, by the recruitment platform, event tracking data from a statistician for an athletics competition associated with the sports coach and the one or more athletes, wherein the event tracking data corresponds to events that occur during the athletics competition;
determine, by the recruitment platform, event statistics data for the athletics competition based on the event tracking data, wherein the event statistics data for a respective athlete corresponds to one or more statistics associated with the respective athlete during the athletics competition;
update, by the recruitment platform, the athlete profile data for the one or more athletes based on the event statistics data;
generate, by the recruitment platform, athlete profile visualization data for the one or more athletes based on the updated athlete profile data, wherein the athlete profile visualization data is configured for use in generating one or more athlete profile interfaces for a computing device; and
transmit, by the recruitment platform, the athlete profile visualization data to the computing device.

16. The non-transitory computer-readable medium of claim 15, wherein the tracking data comprises a log of the events that occur during the athletics competition.

17. The non-transitory computer-readable medium of claim 16, wherein the log of the events is provided by the statistician in real-time or near real-time.

18. The non-transitory computer-readable medium of claim 15, wherein transmitting, by the recruitment platform, the athlete profile visualization data comprises transmitting, by the recruitment platform, the athlete profile visualization data for the respective athlete to the computing device.

19. The non-transitory computer-readable medium of claim 15, wherein the one or more statistics associated with the respective athlete during the athletics competition comprises one or more statistics accumulated by the respective athlete during the athletics competition.

20. The non-transitory computer-readable medium of claim 15, wherein the coach profile data is received from the sports coach using a first application associated with the recruiting platform, wherein the event tracking data is received from the statistician using a second application, and wherein the first application and the second application are different.
